(19) United States
(12) Patent Application Publication
(10) Pub. No.: US 2023/0073900 A1
(43) Pub. Date: Mar. 9, 2023

(54) INSTALLATION SITE OF A ROBOT MANIPULATOR

(71) Applicant: Franka Emika GmbH, München (DE)

(72) Inventor: Andreas Spenninger, Karlsfeld (DE)

(21) Appl. No.: 17/795,963

(22) PCT Filed: Feb. 10, 2021
(86) PCT No.: PCT/EP2021/053132

§ 371 Date: Jul. 28, 2022

(30) Foreign Application Priority Data
Feb. 19, 2020 (DE) 10 2020 104 356.2

(51) Int. Cl. B25J 19/00; B25J 9/16; B25J 9/00; G06F 30/13; G06F 30/27; G06T 7/70

(52) U.S. Cl. CPC B25J 19/007; B25J 9/1605; B25J 9/0087; B25J 9/1607; G06F 30/13; G06F 30/27; G06T 7/70; G06T 2207/20084; G06T 2207/20101

(57) ABSTRACT

A method of determining an installation site of a robot manipulator at a workstation, the method including: recording a respective image of the robot manipulator and of the workstation of the robot manipulator, and of a workpiece to be machined at the workstation via a camera unit, wherein the respective image contains spatial information; transmitting the respective image to a computing unit; and determining the installation site of the robot manipulator by applying a non-linear optimization of a predefined cost function and/or of a neural network via the computing unit based on a predefined task for machining the workpiece and based on the spatial information determined by the computing unit from the respective image.

### CROSS-REFERENCE TO RELATED APPLICATIONS

The present application is the U.S. National Phase of PCT/EP2021/053132, filed on 10 Feb. 2021, which claims priority to German Patent Application No. 10 2020 104 356.2, filed on 19 Feb. 2020, the entire contents of which are incorporated herein by reference.

### BACKGROUND

### Field

The invention relates to a method for determining an installation site of a robot manipulator at a workstation and a system for determining an installation site of a robot manipulator at a workstation.

### SUMMARY

The object of the invention is to determine an installation site of a robot manipulator for performing a specified task with the least possible effort and optimized for the specified task to be performed.

The invention results from the features of the independent claims. Advantageous refinements and embodiments are the subject matter of the dependent claims.

A first aspect of the invention relates to a method of determining an installation site of a robot manipulator at a workstation, wherein the method includes:
recording a respective image of the robot manipulator and of the workstation of the robot manipulator and of a workpiece to be machined at the workstation via a camera unit, wherein the respective image contains spatial information;
transmitting the respective image to a computing unit; and
determining the installation site of the robot manipulator by applying a non-linear optimization of a predefined cost function and/or a neural network via the computing unit based on parameters of a predefined task for machining the workpiece and based on spatial information determined by the computing unit from the respective image.

The installation site of the robot manipulator relates, in particular, to a position of the base or a pedestal of the robot manipulator relative to the workstation, in particular, at a production site. For such an installation site, it is important that a workpiece to be machined can be reached easily and quickly, in particular, by an end effector of the robot manipulator. According to the invention, this is advantageously achieved based on an image recorded by a camera unit. The camera unit is preferably a stereo camera unit or a camera unit consisting of a large number of individual cameras, so that spatial information is contained in the image.

The camera unit is preferably arranged on a portable end device for a user. The portable end device for the user is, in particular, a mobile phone, a tablet or laptop computer or the like. If the camera unit is used on such a portable end device for a user, the multiple lenses of the camera unit of the portable end device can be used as a stereo camera unit in order to generate spatial information of the image, since modern portable end devices are typically equipped with high-quality camera units and are provided with multiple lens systems. Existing portable end devices for users can thus advantageously be used in order to determine the installation site of the robot manipulator.

The respective image can be recorded by the camera unit in various embodiments:

On the one hand, a joint picture of the robot manipulator, the workstation of the robot manipulator, and the workpiece to be machined can be recorded at the workstation of the robot manipulator. In this case, a single image includes both the robot manipulator, the workstation, and the workpiece. These three elements (robot manipulator, workpiece, workstation) are therefore included in a single photograph. As a result, it is advantageously only necessary to record a single image including the robot manipulator, the workstation, and the workpiece. Further images are not necessary according to this embodiment.

Furthermore, a respective image can be recorded offset in time and/or space by the camera unit. A single camera image from the camera unit can record the robot manipulator, another image from the camera unit can record the workstation, and a third image from the camera unit can finally record the workpiece. In this case, the individual images can be combined to form a common image, wherein the spatial information of the respective image with the respective one of the elements (robot manipulator, workpiece, workstation) per image relative to the camera unit a corresponding relative spatial information between the three elements (robot manipulator, workpiece, workstation) can also be generated by using the respective relative position information and/or relative orientation information of the respective element on the respective image (workpiece, robot manipulator, workstation) relative to the camera unit and by assembling the individual images a relative position can be generated between the robot manipulator and the workpiece with respect to the working space. The installation site of the robot manipulator is known, in particular, or is hypothetically assumed, as is used several times in optimization.

In addition, the robot manipulator can be recorded at its workstation in a single image, with the workpiece being recorded in a second image. In this case, a total of two images are recorded and their spatial information is combined.

This results in embodiments, in which an image is recorded that contains the robot manipulator, workstation and workpiece, as well as multiple images that each contain a recording of one of the elements from the robot manipulator, workstation, workpiece or two of these elements.

The computing unit is, in particular, a control unit of the robot manipulator. Alternatively, the computing unit is preferably a user computer connected to a separate control unit of the robot manipulator. The computing unit is designed, in particular, to process the spatial information of the one or more images and thus generate a computer-generated spatial image of the workpiece and robot manipulator relative to one another and in relation to the work space, similar to a CAD system or a three-dimensional simulation. In particular, the relative position of the robot manipulator of the workstation, also with regard to the later relative nominal position between the workpiece and the robot manipulator, is the subject of the investigation in the next step, since this respective relative position has to be optimized. A comprehensive picture of the installation site of the robot manipulator in relation to its workstation and in relation to possible positions or in relation to a nominal position of the workpiece is preferably considered. The information provided by the respective image about a spatial extension of the robot manipulator and the workpiece is thus taken into account. In this case, the optimal installation site is determined by the computing unit by performing a non-linear optimization and/or by the application of an artificial neural network.

A non-linear optimization basically serves to minimize a cost function or to maximize a cost function, which is then preferably called a quality function. The aim of non-linear optimization is to change parameters and variables that can be changed at least over certain ranges in such a way that the structurally specified cost function that is dependent on these parameters or variables is minimized. This predetermined cost function includes, in particular, a sum of terms, wherein the terms are preferably formed based on at least one of the following: an execution speed of the task; a time necessary for machining the workpiece; wear and tear encountered in performing the task; inertial forces encountered in performing the task; a center of gravity deflection of the robot manipulator from a predetermined axis; an energy consumption in performing the task; transport routes of the workpiece, so that before processing by the robot manipulator, the workpiece can be taken as optimally as possible from a box or from a conveyor belt or another storage container and transported to another box, or another conveyor belt, or another storage location after the workpiece has been processed; a maximum payload that the robot manipulator can carry with respect to the workpiece; the trajectory of a center of gravity of the workpiece and/or the robot manipulator; a moment of inertia of the robot manipulator, in particular, with respect to a vertical axis or the like running through a pedestal or base of the robot manipulator; the inverse of a measure of manipulability, so that the value of the cost function increases as the measure of manipulability decreases (for an explanation of the term “measure of manipulability”, see below).

The fact that the machining of the workpiece can be carried out at all as intended can be provided as a further term. Alternatively, the feasibility of carrying out the task per se is preferably used as a restriction of a non-linear optimization that is then restricted. In particular, a possible installation site of the robot manipulator is varied until the cost function has exceeded a predetermined threshold value, or a change in the cost function below a predetermined threshold value is provided. The respective value of the respective individual terms of the cost function results from the spatial information of the image and, in particular, from a corresponding simulation or an analytical solution, from which poses and movement patterns of the robot manipulator for the individual portions of the task are known depending on the assumed installation site.

The use of the artificial neural network requires, in particular, that the artificial neural network has already been trained with given data. If such an artificial neural network is available in a trained form, parameters of the task, in particular, must then be specified as input data for the artificial neural network, so that the artificial neural network provides a corresponding result in the sense of a mathematical mapping based on its learned parameters and functions, where the optimal installation site for the robot manipulator is positioned in relation to the workstation, taking into account the spatial information of the robot manipulator or the workpiece.

It is therefore an advantageous effect of the invention that the optimal installation site of a robot manipulator for executing a specified task is determined automatically and thus in a short time only based on one or more images recorded by a camera unit.

According to an advantageous embodiment, the method also includes the execution of the specified task by the robot manipulator from the determined installation site of the robot manipulator.

According to a further advantageous embodiment, the method also includes:
outputting information about the determined installation site as a suggestion for a user at an output unit; and
detecting an input by the user at an input unit, the input including a correction of the suggestion or a confirmation of the suggestion.

The output unit is preferably a screen of the user's portable end device, or a screen of a user computer, a display of 3D glasses, a hologram, or the like. In addition, the output unit is preferably connected to the input unit, and the display unit and input unit are particularly preferably arranged in the same component, for example, on a touch-sensitive screen. The suggestion for the virtual geometric volume shape is also preferably displayed in a 3D view, so that the user can rotate and move the suggested installation site, in particular, by swiping gestures or by making entries, as in common CAD systems, in order to get a comprehensive impression of the suggested installation site.

According to a further advantageous embodiment, the cost function of the non-linear optimization is dependent on a type of regulator implemented in a regulator of the robot manipulator and/or the type of generation of a movement command in the regulator and/or parameters of the specified task, and/or an input variable of the neural network is the type of regulator implemented in the regulator of the robot manipulator and/or the type of generation of a movement command in the regulator and/or parameters of the specified task. Possible regulators of the robot manipulator are, in particular: force regulators, position regulators, impedance regulators, admittance regulators, speed regulators. Types of a movement command include, in particular, the trajectories of the joint angles, the trajectories in the Cartesian, in particular earth-based coordinate systems, trajectories with constant speed, the combination of dynamic movement primitives. Parameters of the given task are, in particular, a starting point and an end point that indicate how the workpiece is to be transported before and after machining, a force that is to be exerted on the workpiece by the robot manipulator, trajectories, a speed, an acceleration.

According to a further advantageous embodiment, the images of the robot manipulator and the workstation are contained in a common photograph.

According to a further advantageous embodiment, the computing unit determines, in addition to the installation site, an installation orientation of the robot manipulator by determining at least one angle of inclination. In particular, when the most proximal limb of an arm of a robot manipulator is adjustable relative to its pedestal or base, this degree of freedom can be used to also account for an angle of inclination at the installation site of the robot manipulator. A selection can also be made if several pedestals with different angles of inclination are available. Furthermore, there may be the option that the robot manipulator is placed either on a floor or on a vertical wall, which corresponds to a discrete set with two possible variables in the nonlinear optimization or a decision of the neural network for one of the two variables. Advantageously, with this embodiment, additional degrees of freedom can be used and the optimization of the installation site can be further refined.

According to a further advantageous embodiment, the installation site of the robot manipulator is determined by geometric modeling of objects at the workstation and/or the robot manipulator and/or the workstation in geometric bodies. This advantageously simplifies the non-linear optimization or the decision of the artificial neural network, since all elements of the workstation or at least a part of the objects at the workstation including the robot manipulator and the workpiece as well as the space at the workstation itself are divided into analytically easily describable forms and are modeled as such. This means that a finite number of combinations are available for how the geometric objects behave relative to one another. Furthermore, it is advantageously assumed that a reference point of the robot manipulator, in particular, the end effector of the robot manipulator, can only be located at these discrete locations in the room at the workstation.

According to a further advantageous embodiment, the geometric modeling in geometric bodies takes place by assigning the objects at the workstation, the robot manipulator and the workstation to basic geometric shapes predefined in a database with a finite number of different discrete variables.

According to a further advantageous embodiment, the geometric bodies include at least one of the following: sphere, cube, cylinder, and three-dimensional hexagon.

According to a further advantageous embodiment, the installation site of the robot manipulator is determined based on a simulation with modeled effects of technical mechanics, so that mechanical interactions between the robot manipulator and objects from the environment of the robot manipulator are taken into account. Such a simulation with modeled effects of technical mechanics is referred to as a “physics engine”, particularly in the games industry and in technical simulation. Such a “physics engine” reproduces, in particular, the basic laws of technical mechanics, in particular, momentum transmission, static power transmission, inertia, friction and, in particular, also non-linear material effects. The application of the “physics engine” allows the non-linear optimization or the artificial neural network to realistically estimate the effects of a change in the installation site of the robot manipulator.

According to a further advantageous embodiment, the robot manipulator has two robot arms and the suggestion for the installation site is determined by maximizing a common work space with respect to a respective end effector of the respective robot arm.

According to a further advantageous embodiment, the cost function is a quality function to be maximized, the quality function being determined based on a respective degree of manipulability determined for a large number of poses of the robot manipulator, wherein a respective manipulability measure being determined based on a Jacobian matrix valid for a respective pose. The degree of manipulability results in particular from the consideration of the convertibility of the Jacobian matrix valid for a respective pose of the robot manipulator. If the Jacobian matrix is singular, i.e., leads to matrix components tending towards infinity during inversion, forces and/or torques in certain directions can hardly or not at all be recorded (in the case of torque sensors in the joints of the robot manipulator) and can hardly or not at all be applied on the environment by the robot manipulator.

According to a further advantageous embodiment, the degree of manipulability is used conversely as a proportion of the cost function, which means that the cost function increases as the degree of manipulability decreases.

A further aspect of the invention relates to a system for determining the installation site of a robot manipulator at a workstation, having a camera unit and a computing unit, wherein the camera unit is used for taking a respective image of the robot manipulator and of the workstation of the robot manipulator and of a workpiece to be machined at the workstation, wherein the respective image has spatial information, and wherein the camera unit is designed to transmit the respective image to the computing unit, and wherein the computing unit determines the installation site of the robot manipulator by applying a non-linear optimization of a predetermined cost function and/or a neural network is executed by the computing unit based on a predetermined task for processing the workpiece and based on spatial information determined by the computing unit from the respective image.

Advantages and preferred refinements of the proposed system result from an analogous and corresponding transfer of the statements made above in conjunction with the proposed method.

Further advantages, features, and details will be apparent from the following description, in which—possibly with reference to the drawings—at least one example embodiment is described in detail. The same, similar, and/or functionally identical parts are provided with the same reference numerals.

### BRIEF DESCRIPTION OF THE DRAWINGS

In the drawings:

FIG. 1 shows a method for determining an installation site of a robot manipulator according to an example embodiment of the invention; and

FIG. 2 shows a corresponding system for determining the installation site of the robot manipulator according to an example embodiment of the invention.

The illustrations in the figures are schematic and not to scale.

### DETAILED DESCRIPTION

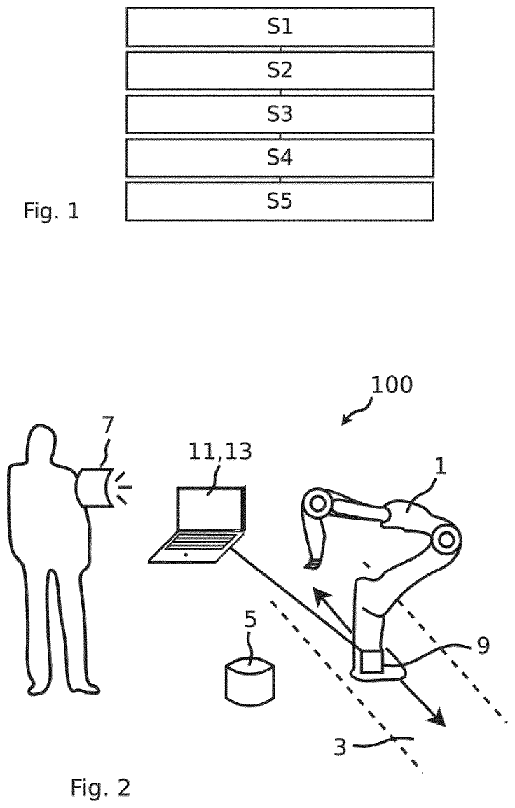

FIG. 1 shows a method for determining an installation site of a robot manipulator 1 at a workstation 3, wherein the method includes:
recording S1 a respective image of the robot manipulator 1 and of the workstation 3 of the robot manipulator 1 and of a workpiece 5 to be machined at the workstation 3 via a camera unit 7, wherein the respective image contains spatial information;
transmitting S2 the respective image to a computing unit 9;
determining S3 the installation site of the robot manipulator 1 by applying a non-linear optimization of a predefined cost function and/or a neural network via the computing unit 9 based on a predefined task for machining the workpiece 5 and based on the spatial information determined by the computing unit 9 from the respective image;
outputting S4 information about the determined installation site as a suggestion for a user at an output unit 9; and
detecting S5 an input by the user at an input unit 11, the input including a correction of the suggestion or a confirmation of the suggestion.

This method is carried out on a system 100 for determining the installation site of the robot manipulator 1. The reference symbols and terms mentioned above therefore also relate to the description of FIG. 2, which can also be used here. Further details of the method following this example embodiment are therefore explained in more detail under the description of FIG. 2.

FIG. 2 shows a system 100 for determining an installation site of a robot manipulator 1 at a workstation 3. The system 100 includes a camera unit 7 and a computing unit 9. The camera unit 9 has a plurality of lens systems and is part of the user's cell phone. The camera unit 9 is capable of capturing multiple images from multiple starting points by using the different lenses and therefore includes spatial information in the image data. The camera unit 9 is also used to record an image of robot manipulator 1 at its initial position at workstation 3. The camera unit 9 is also used to record another image of a workpiece 5 to be machined. These images from camera unit 7 are sent to the computing unit 9 of the robot manipulator 1. The computing unit 9 determines the installation site of the robot manipulator 1 by applying a non-linear optimization of a predefined cost function based on a predefined task for machining the workpiece 5 and based on spatial information determined by the computing unit 9 from the respective image. The cost function is composed of the sum of the squares of the energy required and of the time required for the robot manipulator 1. The energy and time required for the respective execution of the task for the respective installation site is determined by a simulation in which the task is performed virtually for each assumed installation site of the robot manipulator. The various installation sites are selected and evaluated quasi-randomly with the help of an evolution algorithm. In this case, predefined regulator types are evaluated by the computing unit 9. This variation flows directly into the determination of the respective value for the cost function with regard to the respective installation site.

Although the invention has been further illustrated and described in detail using preferred example embodiments, the invention is not limited by the disclosed examples, and other variations can be derived therefrom by a person skilled in the art without departing from the scope of protection of the invention. It is therefore clear that several possible variations exist. It is also clear that example embodiments are really only examples, which are not to be construed in any way as limiting the scope, applicability, or configuration of the invention. Rather, the foregoing description and description of the figures enable a person skilled in the art to implement the example embodiments, and such person may make various changes based on the knowledge of the disclosed inventive concept, for example with respect to the function or arrangement of individual elements cited in an example embodiment, without departing from the scope as defined by the claims and their legal equivalents, such as a more extensive explanation in the description.

### LIST OF REFERENCE NUMERALS

1 robot manipulator
3 workstation
5 workpiece
7 camera unit
9 computing unit
11 input unit
13 output unit
100 system
S1 recording
S2 transmitting
S3 determining
S4 outputting
S5 detecting

1. A method of determining an installation site of a robot manipulator at a workstation, the method comprising:
recording a respective image of the robot manipulator and of the workstation of the robot manipulator, and of a workpiece to be machined at the workstation via a camera unit, wherein the respective image contains spatial information;
transmitting the respective image to a computing unit; and
determining the installation site of the robot manipulator by applying a non-linear optimization of a predefined cost function and/or a neural network via the computing unit based on a predefined task for machining the workpiece and based on the spatial information determined by the computing unit from the respective image.

2. The method of claim 1, the method further comprising:
outputting information about the installation site as determined, as a suggestion for a user at an output unit; and
detecting an input by the user at an input unit, wherein the input includes a correction of the suggestion or a confirmation of the suggestion.

3. The method of claim 1, wherein the cost function of the non-linear optimization is dependent on a type of regulation implemented in a regulator of the robot manipulator and/or a type of generation of a movement command in the regulator and/or parameters of the predefined task, and/or wherein an input variable of the neural network is the type of regulation implemented in the regulator of the robot manipulator and/or the type of generation of the movement command in the regulator and/or parameters of the predefined task.

4. The method of claim 1, wherein images of the robot manipulator and of the workstation are contained in a common photograph.

5. The method of claim 1, the method further comprising, in addition to the installation site, determining an installation orientation of the robot manipulator via the computing unit by determining at least one angle of inclination.

6. The method of claim 1, wherein the installation site of the robot manipulator is determined by geometric modeling of objects at the workstation and/or of the robot manipulator and/or of the workstation in respective geometric bodies.

7. The method of claim 1, wherein the installation site of the robot manipulator is determined based on a simulation with modeled effects of technical mechanics, such that mechanical interactions between the robot manipulator and objects from a vicinity of the robot manipulator are taken into account.

8. The method of claim 2, wherein the robot manipulator comprises two robot arms and the suggestion for the installation site is determined by maximizing a common work space with respect to a respective end effector of a respective robot arm.

9. The method of claim 1, wherein the cost function is a quality function to be maximized, the quality function being determined based on a respective degree of manipulability determined for a large number of poses of the robot manipulator, wherein the respective degree of manipulability is determined based on a Jacobian matrix valid for a respective pose.

10. A system to determine an installation site of a robot manipulator at a workstation, the system comprising:
a camera unit configured to record a respective image of the robot manipulator and of the workstation of the robot manipulator and of a workpiece to be machined at the workstation, wherein the respective image contains spatial information, and wherein the camera unit is configured to transmit the respective image; and
a computing unit configured to receive the respective image transmitted from the camera unit and further configured to determine the installation site of the robot manipulator via application of a non-linear optimization of a predefined cost function and/or a neural network based a predefined task for machining the workpiece and based on the spatial information determined by the computing unit from the respective image.

11. The system of claim 10, wherein the computing unit is further configured to:
output information about the installation site as determined, as a suggestion for a user at an output unit; and
detect an input by the user at an input unit, wherein the input includes a correction of the suggestion or a confirmation of the suggestion.

12. The system of claim 10, wherein the cost function of the non-linear optimization is dependent on a type of regulation implemented in a regulator of the robot manipulator and/or a type of generation of a movement command in the regulator and/or parameters of the predefined task, and/or wherein an input variable of the neural network is the type of regulation implemented in the regulator of the robot manipulator and/or the type of generation of the movement command in the regulator and/or parameters of the predefined task.

13. The system of claim 10, wherein images of the robot manipulator and of the workstation are contained in a common photograph.

14. The system of claim 10, wherein the computing unit is further configured to, in addition to the installation site, determine an installation orientation of the robot manipulator by determining at least one angle of inclination.

15. The system of claim 10, wherein the installation site of the robot manipulator is determined by geometric modeling of objects at the workstation and/or of the robot manipulator and/or of the workstation in respective geometric bodies.

16. The system of claim 10, wherein the installation site of the robot manipulator is determined based on a simulation with modeled effects of technical mechanics, such that mechanical interactions between the robot manipulator and objects from a vicinity of the robot manipulator are taken into account.

17. The system of claim 11, wherein the robot manipulator comprises two robot arms and the suggestion for the installation site is determined by maximizing a common work space with respect to a respective end effector of a respective robot arm.

18. The system of claim 10, wherein the cost function is a quality function to be maximized, the quality function being determined based on a respective degree of manipulability determined for a large number of poses of the robot manipulator, wherein the respective degree of manipulability is determined based on a Jacobian matrix valid for a respective pose.
